(19) United States
(12) Patent Application Publication
(10) Pub. No.: US 2008/0287081 A1
(43) Pub. Date: Nov. 20, 2008

(54) Receiver for Receiving Multiple Standards

(75) Inventors: Catharina Johanna Henrica Van Dam, Redhill (GB); David Hillary Evans, Crawley (GB); Richard John Caldwell, Reigate (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,908

(22) PCT Filed: Apr. 12, 2005
(86) PCT No.: PCT/IB05/51200

§ 371 Date: Oct. 13, 2006

(30) Foreign Application Priority Data
Apr. 16, 2004 (EP) 04252223.5

(51) Int. Cl. H04B 1/40

(52) U.S. Cl. 455/142

(57) ABSTRACT

A receiver is arranged to receive at least two RF signals (51,52). A first RF signal of the at least two radio frequency signals (S] 5S2) is having a first center frequency, whilst a second signal of the at least two RF radio frequency signals (si,s2) is having a second center frequency, the receiver comprises a frequency shifter (10,11) arranged to shift the first center frequency to the second center frequency and a combiner (12) arranged to combine the frequency shifted first RF signal _{(S3)} with the second RF signal (si) so as to obtain a combined RF signal (s4). The receiver further comprising a frequency down converter (15,16) arranged to frequency down convert the combined RF signal (s4) to a combined lower frequency signal and a demodulator (19) arranged to demodulate the combined lower frequency signal.

The invention relates to a receiver arranged to receive at least two RF signals and to a mobile terminal comprising such receiver. The invention also relates to a method for receiving at least two RF signals.

The interest in combining multiple wireless services into a single mobile terminal is well known. For example the combination of 3G services such as UMTS with DVB services to enable a mobile UMTS terminal in receiving video broadcasted signals.

It is an object of the present invention to provide a receiver for receiving at least two RF signals in an efficient way. Therefore, the receiver which is arranged to receive at least two RF signals, wherein a first RF signal of the at least two radio frequency signals has a first center frequency and a second signal of the at least two RF radio frequency signals has a second center frequency, comprises:

a frequency shifter arranged to shift the first center frequency to the second center frequency; and

a combiner arranged to combine the frequency shifted first RF signal with the second RF signal so as to obtain a combined RF signal;

a frequency down converter arranged to frequency down convert the combined RF signal to a combined lower frequency signal; and

a demodulator arranged to demodulate the combined lower frequency signal;

The invention is based upon the insight that by combining the received RF signals it is possible to process the two received RF signal with a single RF front end. This however requires that the center frequency of the first RF signal coincides or is at least close to the center frequency of the second RF signal.

In an embodiment of a receiver according to the invention, the combiner is arranged to make the first RF signal orthogonal to the second RF signal. By orthoganizing the two RF signals it is possible to add them together such that they can be separated at a later stage.

In another embodiment of a receiver according to the invention, the combiner comprises at least a first multiplexing switch for multiplying the first RF signal with a first code sequence and a second multiplexing switch for multiplying the second RF signal with a second code sequence. By means of selecting suitable code sequences, the signals can be orthogonized in a convenient way. Suitable code sequences could e.g. be derived from the Walsh code. For example by using Wal (0) for one of the switches and Wal (1) for the other one.

In another embodiment of a receiver according to the invention the receiver is arranged to monitor the ether for the presence of the second RF signal. By means of this option, it is possible to interrupt the reception and processing of the first RF signal only in case a relevant second RF signal is aired by some radio source.

In yet another embodiment of a receiver according to the invention, the receiver is arranged to receiver a synchronization signal for synchronizing the reception of the at least two RF signals. Through this it would be possible to simultaneously receive the at least two RF signals with having a problematic loss of information of either one of the at least to RF signals.

In an embodiment of a receiver according to the invention, a bandwidth of the first RF signal is comparable to a bandwidth of the second RF signal. If the bandwidths of the two signals are comparable to each other, it is possible to share further components of the receiver for processing the combined RF signal such as amplifiers, frequency down converters, analogue to digital converters and the demodulator.

These and other aspects of the invention will be further elucidated by means of the following drawings.

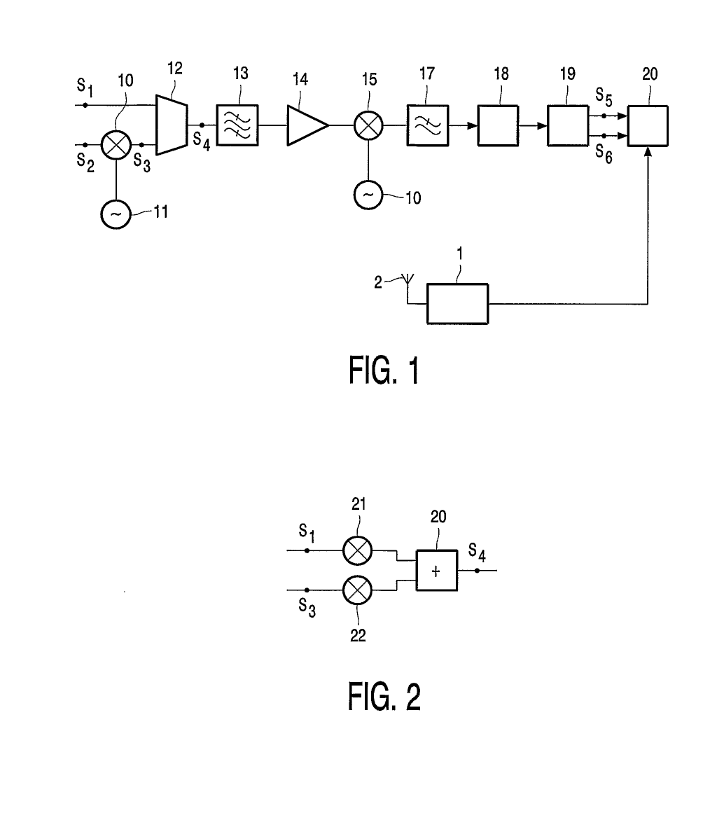

FIG. 1 shows a receiver according to the invention.

FIG. 2 shows an embodiment of the combiner.

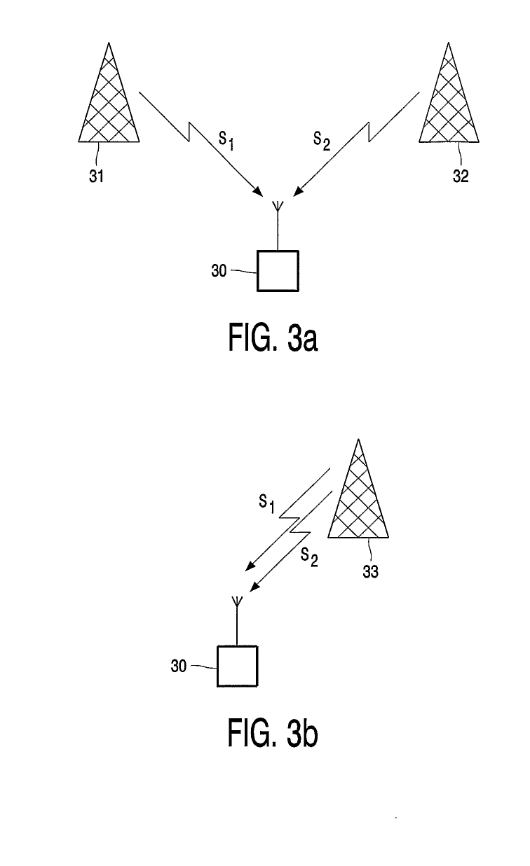

FIG. 3 shows a mobile terminal comprising a receiver according to the invention in its operating environment.

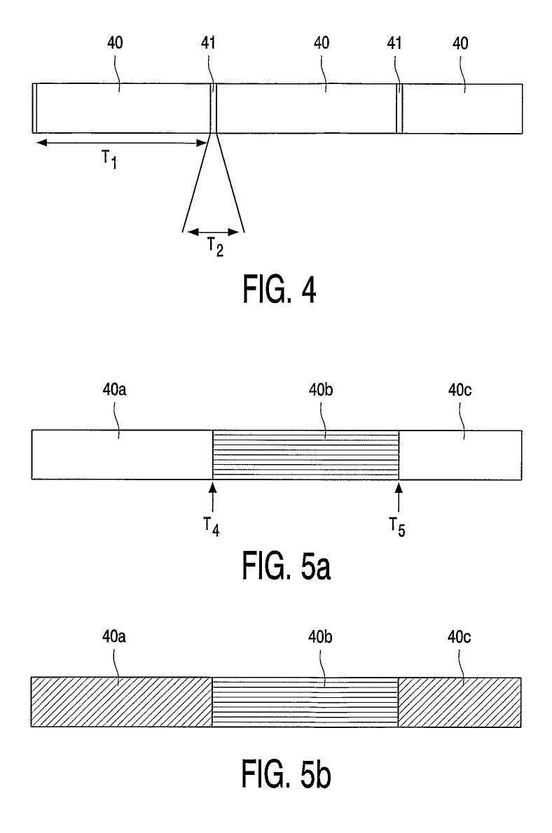

FIG. 4 shows a DVB frame.

FIG. 5 shows a combination of a UMTS transmission and a DVB transmission.

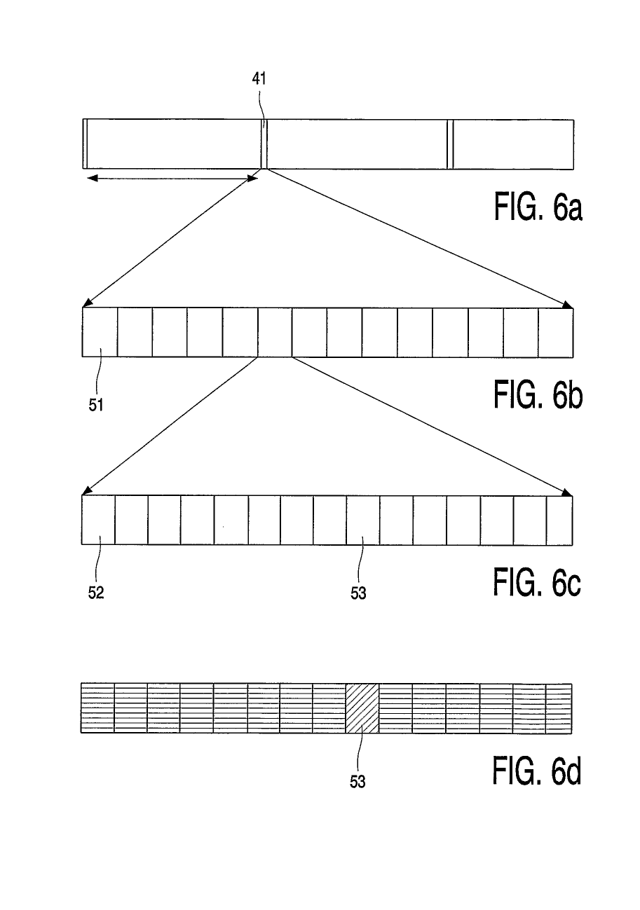

FIG. 6 shows a more detailed view of the combination of a UMTS transmission with a DVB transmission

There is a current interest to combine e.g. DVB services with UMTS in a mobile terminal such as a mobile phone, PDA or alike. In principle the following situations or combinations can be distinguished:

1. Using DVB to receive broadcasted video or TV signals in a mobile terminal.
2. Using the UMTS network for the DVB return channel.
3. Using both networks for the routing of IP packages.

In each of these scenarios, two receivers would be required in a mobile terminal, one for each of the received services (e.g. DVB or UMTS). According to the present invention, it is however possible to use only a single receiver for both DVB and UMTS. This can be achieved by shifting the DVB center frequency (700 MHz) up to the UMTS center frequency (2100 MHz) or vice versa. A possible implementation of a receiver according to the present invention is shown in FIG. 1. Shown is mixer 10 coupled to local oscillator 11 for shifting the center frequency of signal s₂ to the same center frequency of signal s₁. Subsequently signals s₁ and the frequency shifted version of signal s₂ i.e. s₃ are coupled to combiner 12, so that they can be combined into a combined radio frequency signal S₄. The combined radio frequency signal is filtered by means of filter 13 and amplified by means of amplifier 14. Via Mixer 15, the combined radio frequency signal s₄ is frequency down converted to lower frequency signal s₅. To this end mixer 15 is coupled to local oscillator 16. In this context lower frequency means IF or Baseband. The lower frequency signal can be digitized through analogue to digital converter 18 after which it can be demodulated in demodulator 19, to yield the UMTS and DVB signals s₅ and s₆. The receiver further comprises processing means 20 to further process the demodulated UMTS and DVB signals. The processing means could be arranged to detect the presence of one of the signals s₅ and s₆ for example by determining the received signal power of each of the signals s₅ and s₆. Through this it would be possible to switch between the received services that are contained in the signals s₅ and s₆. In principle it would be possible to for example give one signal preference over the other according to either a pre-defined or user-defined options. Additionally the receiver could be arranged to receive a synchronization signal for synchronizing the reception of the at least two received RF signal. This signal could e.g. be received a receiver 1 where it is decoded and coupled to e.g. processing means 19. Antenna 2 could also be an antenna through which the other signals s₁ and s₂ are being received. Alternatively, the synchronization signal could be encapsulated in either one of the at least two received RF signals. In this case the processing means 19 or demodulator 18 could be used to extract the synchronization signal from either one of the at least two RF signals.

FIG. 2 shows an example of combiner 12. Signals S₁ and S₃ are coupled to multiplexing switches 21 and 22. The object of these multiplexing switches is to othogonalize signals s₁ and s₃. This has the effect that it is possible to s1 and s3 together whilst at the same time they can be separated at a later instance. The multiplexing switches 21, 22 could be BPSK (0/180 degree) phase modulators that multiply the received signal by a sequence of 1's and −1's. Preferably, the modulators are chosen such that they have a low insertion loss so that they do not degrade the received signals. By multiplying the received signals with the differing sequences, the signals are made orthogonal to each other. At a later stage the combined signal can be separated after frequency down converting using a single receiver. A good example of orthogonal codes and in particular for this application are Walsh functions which are well known to the skilled person. According to the invention Wal (0) could be applied to one of the multiplexing switches 21,22 whilst Wal (1) could be applied to the other one 21,22. Wal (0) means multiplying the received signal with a sequence 1,1 whilst Wal (1) means multiplying the received signal with a sequence 1,−1. Wal (0) denotes a continuous DC signal. Higher order Walsh functions could also be used to encode the received signals.

As an additional means of preserving the integrity of the received signals, the sequences would be applied at twice the nominal sample rate of the received signals. I.e. for each nominal sample period, both parts of the sequence would be applied. Since the DVB signal has the higher sampling rate than UMTS, the sequences would be applied to both received signals at twice the DVB sample rate.

Alternatively the two signals s₁ and s₂ could be combined by using time multiplexing, which too is well known in the art. Here one of the multiplexing switches 21,22 could use the sequence 1,0 whilst the other one would use the sequence 0,1. In principle the multiplexing switches 21,22 could be removed altogether and the (frequency bands of the) two signals could be placed adjacent to each other e.g. by means of the frequency offsetting oscillator 11 and mixer 10.

FIG. 3, shows a mobile terminal 30 comprising a receiver according to FIG. 1 in its operating environment. Two configurations are shown. In FIG. 3a, the mobile station 30 is coupled to two radio sources 31 and 32 for the reception of the two RF signals s₁ and s₂, which could e.g. represent UMTS and DVB signals, which are transmitted to the mobile station 30. In operational situation it could be that not all signal s1 and s2 are active at the same time. In FIG. 3b a situation is shown in which signals s1 and s2 are transmitted from the same location. In this situation, the radio source or radio sources could also emit a synchronization signal (not shown) to the mobile station 30 to synchronize the mobile station with the radio source(s) that emit signals s₁ and s₂. Alternatively, (not shown here) the radio signals s1 and s2 could be combined into a single radio signal beforehand by radio source 33, which could e.g. be a base station.

Digital Video Broadcast (DVB) signals are periodically time slotted signals comprising reception slots 41 and off period slots 42. In a typical variant of DVB called DVB-H, the typical reception slot 41 has a duration T₂ which could be 0.14 s whilst the off period slot 40 duration T₁ could be up to 6 seconds as is shown in FIG. 4. Typically, different program streams are transmitted in different slots, although a DVB receiver does not to receive all of these slots to warrant an acceptable reception, in principle it would be possible to warrant an acceptable reception by receiving at least one reception slot.

It is assumed that in a normal operational mode a mobile station 30 receives predominantly DVB transmissions. However, mobile station 30 also needs to receive some UMTS information so as to remain synchronized with the UMTS network. Since DVB transmissions are time-multiplexed which can be received in approximately 10% of the available time, it is in principle possible to receive the UMTS information during the remaining 90% of the time wherein no DVB transmissions does not need to be received. This arrangement requires some intelligence in either the mobile station or in the network itself, to assure that the DVB and UMTS transmissions remain separated in time. At the terminal this could easily be implemented by simply ignoring DVB reception when UMTS reception is required. In the network, it could be established by synchronizing DVB and UMTS transmissions for example by co-locating the radio sources for DVB and UMTS and coordinating the transmit time of each of the radio sources. If the functionality is only implemented in a mobile terminal DVB packets will inevitably be lost.

This is elaborated in more detail in FIG. 5. It is assumed that in this embodiment UMTS reception is on standby whilst a digital video broadcast is received during period 40c. This means that there are no simultaneous connections. However the receiver constantly monitors the UMTS communication channels, e.g. by monitoring the received signal strength or by monitoring the channel in the digital domain. This could be done by the processing unit 19 of FIG. 1. At time T4, a UTMS communication e.g. a connection request is detected by the receiver. Consequently, the receiver interrupts DVB reception and the receiver effectively reduces to a UMTS receiver. Once the UMTS connection is terminated at time T5, the DVB transmission is resumed which is denoted by 40c.

Better performance could be achieved by incorporating, some additional intelligence in the network. Synchronizing the mobile terminal 30 with the network would be a first step. A UMTS frame (FIG. 6c) comprises fifteen time slots 52 which added together have a duration of 10 ms i.e. 0.66 ms per timeslot. The DVB reception slot 41 (FIG. 6a) has a duration of 14 ms, and the slot is subdivided into 14 time slot 51 (FIG. 6b), each having a duration of 10 ms. This means that the UMTS frame of FIG. 6c “fits” into a DVB slot 51 of FIG. 6b. This is shown in more detail in FIG. 6d.

This can easily be achieved by synchronizing the UMTS and DVB transmissions in the network. The objective of synchronization is to align the timings of the frames of the UMTS signal and the DVB signal. The UMTS signal has a frame period of 10 ms. That for DVB is much longer and also variable. Another key feature of the synchronization process would be to inform the UMTS transmitter of when the DVB transmissions are taking place and how often these are repeated. In this case the DVB receiver would indicate to the UMTS transmitter when the UMTS transmissions would not be able to be received by the Mobile station. This would require an interaction between the UMTS transmitter and the DVB transmitter.

Nevertheless, the receiver still needs to synchronize to both the UMTS and DVB received signals. In pure UMTS mode it could e.g. synchronize in the same way as a conventional UMTS mobile phone. When DVB reception is required, the mobile phone would have to determine the timing of the correct part of the DVB frame. This could e.g. be achieved by extracting and using the timing information which may be available in either one of the signals or alternatively, the network could provide dedicated synchronization signals to the mobile station which could minimize data loss even further because this way UMTS and DVB signals could be transmitted in an alternating fashion. These synchronization signals could be additional signals that are being aired by either one of the radio sources 31, 32, 33 (FIG. 3) or they could be incorporated into e.g. the UMTS or DVB signal, e.g. by assigning a dedicated slot of the communication for synchronization information.

According to this more complex procedure, it would be possible to establish and maintain simultaneous connections between the network and the mobile station. This means that it is possible to maintain a video connection while at the same time an UMTS connection is in place. According to this procedure the it would be possible to transmit DVB signals, during periods of time during which the slots 52 of the UMTS frame are “empty”. However, DVB transmission must be halted by the radio source or alternatively ignored by the receiver during periods when UMTS information is aired/received. In FIGS. 5c and 5d, this period is represented by slot 53. Since switching between UMTS and DVB can be very fast, typically around 10 μs, only 1 UMTS slot per frame would be lost due to this. This would amount to a loss of 14*10/15=9.3 ms every 6 seconds which is less than 0.2% of the DVB reception time. Given the availability of high level error correction methods that are available in for example MPEG a loss of less than 0.2% is unproblematic.

It should be noted that the above-mentioned embodiments illustrate rather than limit the invention, and that those skilled in the art will be able to design many alternative embodiments without departing from the scope of the appended claims. All signal processing shown in the above embodiments can be carried in the analogue domain and the digital domain. The word “comprising” does not exclude the presence of elements or steps other than those listed in a claim. The mere fact that certain measures are recited in mutually different dependent claims does not indicate that a combination of these measures cannot be used to advantage.

1. Receiver arranged to receive at least two RF signals (s₁,s₂), wherein a first RF signal of the at least two radio frequency signals (s₁,s₂) has a first center frequency and a second signal of the at least two RF radio frequency signals (s₁,s₂) has a second center frequency, the receiver comprising:
a frequency shifter (10,11) arranged to shift the first center frequency to the second center frequency; and
a combiner (12) arranged to combine the frequency shifted first RF signal (s₃) with the second RF signal (s₁) so as to obtain a combined RF signal (s4);
a frequency down converter (15,16) arranged to frequency down convert the combined RF signal (s4) to a combined lower frequency signal; and
a demodulator (19) arranged to demodulate the combined lower frequency signal.

2. Receiver according to claim 1, wherein the combiner (12) is arranged to make the first RF signal (s₂) orthogonal to the second RF signal (s₁).

3. Receiver according to claim 2, wherein the combiner (12) comprises at least a first (22) multiplexing switch for multiplying the first RF signal (s₂) with a first code sequence and a second multiplexing switch (21) for multiplying the second RF signal (s₁) with a second code sequence.

4. Receiver according to claim 2, wherein the multiplexing switches (21,22) are BPSK phase modulators.

5. Receiver according to claim 3, wherein the first and second code sequences are applied to the first and second RF signals (s₁,s₂) at a rate which is equal to at least twice the sample rate of the corresponding first and second RF signals (s₁,s₂).

6. Receiver according to claim 3, wherein the first code sequence is a Wal (0) function and the second code sequence is a Wal (1) function.

7. Receiver according to claim 1, wherein the combiner (12) is arranged to time-multiplex the first and second RF signals (s₁,s₂).

8. Receiver according to claim 1, wherein the combiner (12) is arranged to position the frequency band of the at least two RF signals adjacent (s₁,s₂) to each other.

9. Receiver according to claim 1, wherein the receiver is arranged to receive synchronization signals for synchronizing the reception of the at least two RF signals (s₁,s₂).

10. Receiver arranged to claim 1, wherein the receiver is arranged to monitor the ether for the presence second RF signal.

11. Receiver according to claim 1, wherein a bandwidth of the first RF signal (s₂) is comparable to a bandwidth of the second RF (s₁) signal.

12. Receiver according to claim 1, wherein the first RF signal (s₂) is a DVB signal.

13. Receiver according to claim 1, wherein the second RF signal (s₁) is a UMTS signal.

14. Mobile terminal (30) comprising a receiver according to claim 1.

15. Telecommunication system comprising a receiver according to claim 1.

16. Telecommunication system according to claim 15, wherein the network is arranged to emit a synchronization signal for synchronizing the receiver for the reception of the at least two RF signals (s₁,s₂).

17. Telecommunication system according to claim 15, comprising at least two radio sources for emitting at least two RF signals that are arranged to emit the at least two RF signals (s₁,s₂) in a synchronized manner.

18. Telecommunication channel according to claim 17, wherein the at least two radio sources are coupled together in order to synchronize the emission of the at least two RF signals (s₁,s₂).

19. Synchronization signal emitted by a network arranged to synchronize a receiver for the reception of at least two RF signals (s₁,s₂).

20. Synchronization signal according to claim 17, wherein the synchronization signal is incorporated into at least one of the at least two RF signals (s₁,s₂).

21. Method of receiving at least two RF signals, wherein a first RF signal of the at least two RF signals has a first center frequency and a second RF signal of the at least two RF signals has a second center frequency, the method comprising the steps of:
shifting the first center frequency to the second center frequency;
multiplexing the frequency shifted first RF signal together with the second RF signal into a combined RF signal;
frequency down converting the combined RF signal into a combined lower frequency signal; and
demodulating the combined lower frequency signal.
